(19) United States
(12) Patent Application Publication
(10) Pub. No.: US 2022/0012645 A1
(43) Pub. Date: Jan. 13, 2022

(54) FEDERATED LEARNING IN O-RAN

(71) Applicants: Dawei Ying, Hillsboro, OR (US); Leifeng Ruan, Beijing (CN); Jaemin Han, Portland, OR (US); Qian Li, Beaverton, OR (US); Geng Wu, Portland, OR (US)

(72) Inventors: Dawei Ying, Hillsboro, OR (US); Leifeng Ruan, Beijing (CN); Jaemin Han, Portland, OR (US); Qian Li, Beaverton, OR (US); Geng Wu, Portland, OR (US)

(21) Appl. No.: 17/483,590

(22) Filed: Sep. 23, 2021

(51) Int. Cl. G06N 20/20; H04L 29/08; H04W 24/02

(52) U.S. Cl. CPC G06N 20/20; H04W 24/02; H04L 67/02

(57) ABSTRACT

Apparatuses for non real-time (Non-RT) radio access network intelligence controller (RIC) services for machine learning (ML) in an open radio access network (O-RAN) and apparatuses for Near-RT RIC services are disclosed. The services include ML capability query, federated learning session creation, federated learning session deletion, global model download/update, local model upload/update, global model status query, local model status query, global model status notification, and local model status notification. The services may be performed over the A1 interface using HTTP.

### TECHNICAL FIELD

Aspects pertain to wireless communications. Some aspects relate to wireless networks including 3GPP (Third Generation Partnership Project) networks, 3GPP LTE (Long Term Evolution) networks, 3GPP LTE-A (LTE Advanced) networks, (MulteFire, LTE-U), and fifth-generation (5G) networks including 5G new radio (NR) (or 5G-NR) networks, 5G networks such as 5G NR unlicensed spectrum (NR-U) networks and other unlicensed networks including Wi-Fi, CBRS (OnGo), etc. Other aspects are directed to Open RAN (O-RAN) architectures and, more specifically, techniques for providing federated learning services for artificial intelligence (AI) and machine learning (ML) learning in non-real-time (Non-RT) radio access network (RAN) intelligent controllers (RICs) (Non-RT RICs) and Near-RT RICs.

### BACKGROUND

Mobile communications have evolved significantly from early voice systems to today's highly sophisticated integrated communication platform. With the increase in different types of devices communicating with various network devices, usage of 3GPP LTE systems has increased. The penetration of mobile devices (user equipment or UEs) in modern society has continued to drive demand for a wide variety of networked devices in many disparate environments. Fifth-generation (5G) wireless systems are forthcoming and are expected to enable even greater speed, connectivity, and usability. Next generation 5G networks are expected to increase throughput, coverage, and robustness and reduce latency and operational and capital expenditures. 5G new radio (5G-NR) networks will continue to evolve based on 3GPP LTE-Advanced with additional potential new radio access technologies (RATs) to enrich people's lives with seamless wireless connectivity solutions delivering fast, rich content and services. As current cellular network frequency is saturated, higher frequencies, such as millimeter wave (mmWave) frequency, can be beneficial due to their high bandwidth.

Potential LTE operation in the unlicensed spectrum includes (and is not limited to) the LTE operation in the unlicensed spectrum via dual connectivity (DC), or DC-based LAA, and the standalone LTE system in the unlicensed spectrum, according to which LTE-based technology solely operates in the unlicensed spectrum without requiring an “anchor” in the licensed spectrum, called MulteFire. MulteFire combines the performance benefits of LTE technology with the simplicity of Wi-Fi-like deployments.

Further enhanced operation of LTE and NR systems in the licensed, as well as unlicensed spectrum, is expected in future releases and 5G systems such as O-RAN systems. Such enhanced operations can include techniques for AI and ML for O-RAN networks.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various aspects discussed in the present document.

FIG. 1 illustrates an example Open RAN (O-RAN) system architecture.

FIG. 2 illustrates a logical architecture of the O-RAN system of FIG. 1.

FIG. 3 illustrates services of the A1 interface, in accordance with some embodiments.

FIG. 4 illustrates the protocol stack of the A1 interface, in accordance with some embodiments.

FIG. 5 illustrates HTTP roles in A1-ML service framework, in accordance with some embodiments.

FIG. 6 illustrates a method for federated learning between the Non-RT RIC and the Near-RT RIC, in accordance with some embodiments.

FIG. 7 illustrates an AI/ML API resource uniform resource identifier (URI), in accordance with some embodiments.

FIG. 8 illustrates a method for querying ML capability, in accordance with some embodiments.

FIG. 9 illustrates a method for querying for a specific ML capability, in accordance with some embodiments.

FIG. 10 illustrates a method for creating a FL session, in accordance with some embodiments.

FIG. 11 illustrates a method of downloading a global model, in accordance with some embodiments.

FIG. 12 illustrates a method for querying the global model status, in accordance with some embodiments.

FIG. 13 illustrates a method for querying the local model status, in accordance with some embodiments.

FIG. 14 illustrates a method for uploading local models, in accordance with some embodiments.

FIG. 15 illustrates a method of deleting the FL session, in accordance with some embodiments.

FIG. 16 illustrates a method of notifying the global model status, in accordance with some embodiments.

FIG. 17 illustrates a method to notify of a local model status, in accordance with some embodiments.

FIG. 18 illustrates a method for federated learning between a Non-RT RIC and Near-RT RICs, in accordance with some embodiments.

### DETAILED DESCRIPTION

The following description and the drawings sufficiently illustrate aspects to enable those skilled in the art to practice them. Other aspects may incorporate structural, logical, electrical, process, and other changes. Portions and features of some aspects may be included in or substituted for, those of other aspects. Aspects outlined in the claims encompass all available equivalents of those claims.

A technical problem is how to collect and use data to train AI/ML models to use in an O-RAN architecture. Some embodiments address the technical problem with federated learning. O-RAN WG2 AI/ML models may be deployed in differently in O-RAN. For example, an AI/ML model can be trained in a Non-RT RIC and deployed into a Near-RT RIC for inference. One Non-RT RIC may service multiple Near-RT RICs so that Non-RT RIC (or OAM) may obtain an AI/ML models across a large number of Near-RT RICs (or CUs) without collecting all the raw data from RAN. The local data stays within corresponding Near-RT RICs to reduce data transportation cost and to enhance privacy. Some embodiments use the A1 interface, e.g., as described herein and in [R03] and [R04], for communication in federated learning between Non-RT RIC and Near-RT RICs in the O-RAN architecture. Some embodiments provide management services for AI/ML model federated learning between Non-RT RICs and Near-RT RICs.

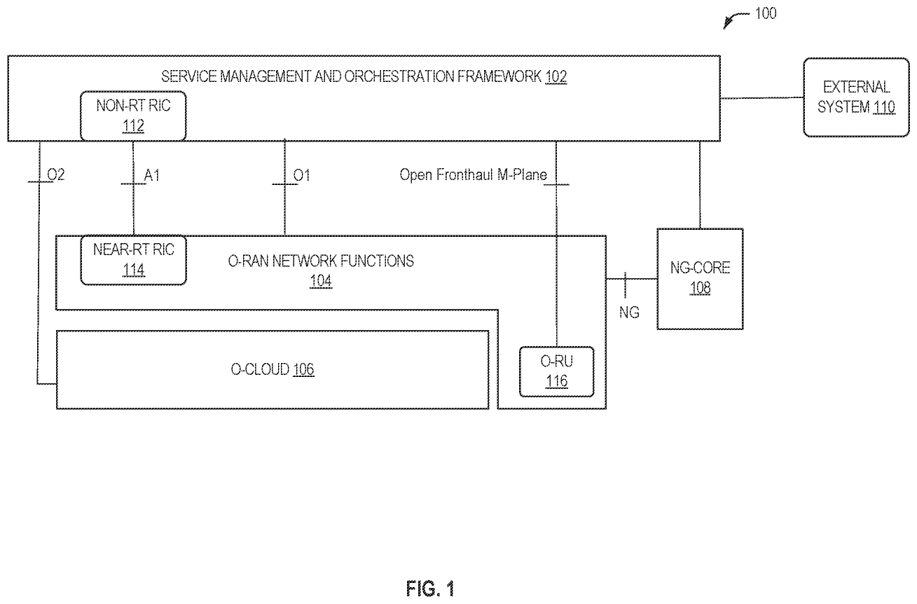

FIG. 1 provides a high-level view of an Open RAN (O-RAN) architecture 100. The O-RAN architecture 100 includes four O-RAN defined interfaces—namely, the A1 interface, the O1 interface, the O2 interface, and the Open Fronthaul Management (M)-plane interface—which connect the Service Management and Orchestration (SMO) framework 102 to O-RAN network functions (NFs) 104 and the O-Cloud 106. The SMO 102 (described in Reference [R13]) also connects with an external system 110, which provides enrichment data to the SMO 102. FIG. 1 also illustrates that the A1 interface terminates at an O-RAN Non-Real Time (RT) RAN Intelligent Controller (RIC) 112 in or at the SMO 102 and at the O-RAN Near-RT RIC 114 in or at the O-RAN NFs 104. The O-RAN NFs 104 can be virtual network functions (VNFs) such as virtual machines (VMs) or containers, sitting above the O-Cloud 106 and/or Physical Network Functions (PNFs) utilizing customized hardware. All O-RAN NFs 104 are expected to support the O1 interface when interfacing with the SMO framework 102. The O-RAN NFs 104 connect to the NG-Core 108 via the NG interface (which is a 3GPP defined interface). The Open Fronthaul M-plane interface between the SMO 102 and the O-RAN Radio Unit (O-RU) 116 supports the O-RU 116 management in the O-RAN hybrid model as specified in Reference [R16]. The Open Fronthaul M-plane interface is an optional interface to the SMO 102 that is included for backward compatibility purposes as per Reference [R16] and is intended for management of the O-RU 116 in hybrid mode only. The management architecture of flat mode (see Reference [R12]) and its relation to the O1 interface for the O-RU 116 is in development. The O-RU 116 termination of the O1 interface towards the SMO 102 as specified in Reference [R12].

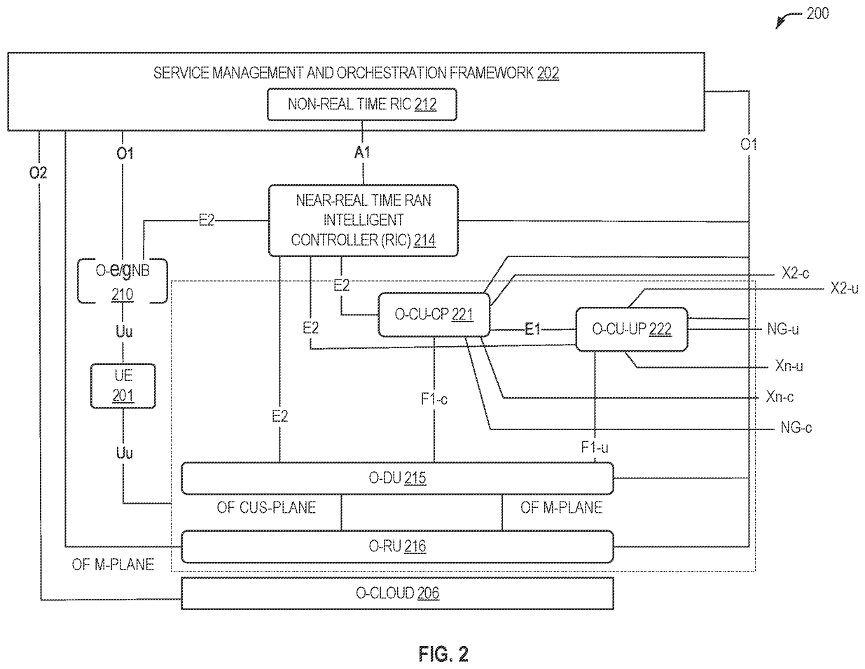

FIG. 2 shows an O-RAN logical architecture 200 corresponding to the O-RAN architecture 100 of FIG. 1. In FIG. 2, the SMO 202 corresponds to the SMO 102, O-Cloud 206 corresponds to the O-Cloud 106, the non-RT RIC 212 corresponds to the non-RT RIC 112, the near-RT RIC 214 corresponds to the near-RT RIC 114, and the O-RU 216 corresponds to the O-RU 116 of FIG. 2, respectively. The O-RAN logical architecture 200 includes a radio portion and a management portion.

The management portion/side of the architectures 200 includes the SMO Framework 202 containing the non-RT RIC 212, and may include the O-Cloud 206. The O-Cloud 206 is a cloud computing platform including a collection of physical infrastructure nodes to host the relevant O-RAN functions (e.g., the near-RT RIC 214, O-RAN Central Unit-Control Plane (O-CU-CP) 221, O-RAN Central Unit-User Plane O-CU-UP 222, and the O-RAN Distributed Unit (O-DU) 215, supporting software components (e.g., OSs, VMMs, container runtime engines, ML engines, etc.), and appropriate management and orchestration functions.

The radio portion/side of the logical architecture 200 includes the near-RT RIC 214, the O-DU 215, the O-RAN Radio Unit (O-RU) 216, the O-CU-CP 221, and the O-CU-UP 222 functions. The radio portion/side of the logical architecture 200 may also include the O-e/gNB 210.

The O-DU 215 is a logical node hosting Radio Link Control (RLC), media access control (MAC), and higher physical (PHY) layer entities/elements (High-PHY layers) based on a lower layer functional split. The O-RU 216 is a logical node hosting lower PHY layer entities/elements (Low-PHY layer) (e.g., FFT/iFFT, PRACH extraction, etc.) and RF processing elements based on a lower layer functional split. Virtualization of O-RU 216 is FFS. The O-CU-CP 221 is a logical node hosting the RRC and the control plane (CP) part of the PDCP protocol. The O-CU-UP 222 is a logical node hosting the user plane part of the PDCP protocol and the SDAP protocol.

An E2 interface terminates at a plurality of E2 nodes. The E2 nodes are logical nodes/entities that terminate the E2 interface. For NR/5G access, the E2 nodes include the O-CU-CP 221, O-CU-UP 222, O-DU 215, or any combination of elements as defined in Reference [R15]. For E-UTRA access the E2 nodes include the O-e/gNB 210. As shown in FIG. 2, the E2 interface also connects the O-e/gNB 210 to the Near-RT RIC 214. The protocols over E2 interface are based exclusively on Control Plane (CP) protocols. The E2 functions are grouped into the following categories: (a) near-RT RIC 214 services (REPORT, INSERT, CONTROL and POLICY, as described in Reference [R15]), and (b) near-RT RIC 214 support functions, which include E2 Interface Management (E2 Setup, E2 Reset, Reporting of General Error Situations, etc.) and Near-RT RIC Service Update (e.g., capability exchange related to the list of E2 Node functions exposed over E2).

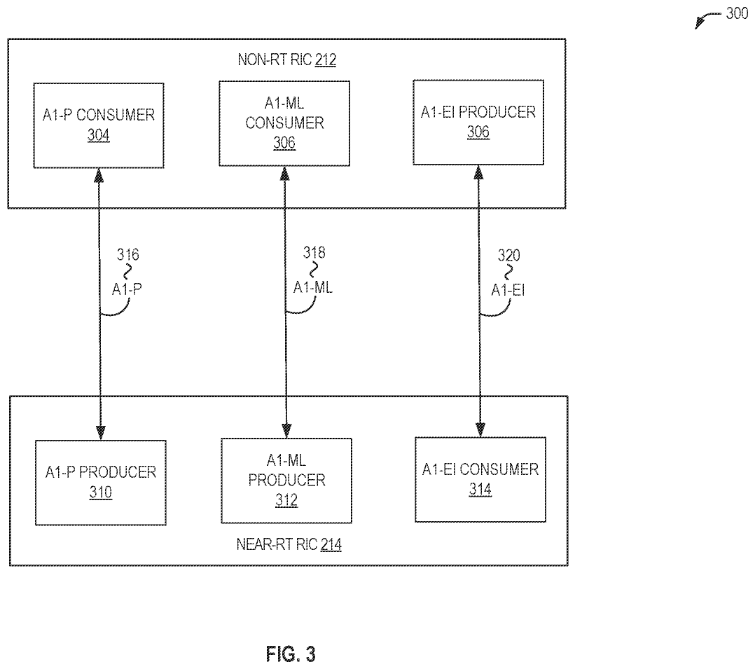

FIG. 2 shows the Uu interface between a UE 201 and O-e/gNB 210 as well as between the UE 201 and O-RAN components. The Uu interface is a 3GPP defined interface (see e.g., sections 5.2 and 5.3 of Reference [R07]), which includes a complete protocol stack from L1 to L3 and terminates in the NG-RAN or E-UTRAN. The O-e/gNB 210 is an LTE eNB (see Reference [R04]), a 5G gNB or ng-eNB (see Reference [R06]) that supports the E2 interface. The O-e/gNB 210 may be the same or similar as discussed in FIGS. 3-18. The UE 201 may correspond to UEs discussed with herein. There may be multiple UEs 201 and/or multiple O-e/gNB 210, each of which may be connected to one another the via respective Uu interfaces. Although not shown in FIG. 2, the O-e/gNB 210 supports O-DU 215 and O-RU 216 functions with an Open Fronthaul interface between them.

The Open Fronthaul (OF) interface(s) is/are between O-DU 215 and O-RU 216 functions (see References [R16] and [R17].) The OF interface(s) includes the Control User Synchronization (CUS) Plane and Management (M) Plane. FIGS. 1 and 2 also show that the O-RU 216 terminates the OF M-Plane interface towards the O-DU 215 and optionally towards the SMO 202 as specified in Reference [R16]. The O-RU 216 terminates the OF CUS-Plane interface towards the O-DU 215 and the SMO 202.

The F1-c interface connects the O-CU-CP 221 with the O-DU 215. As defined by 3GPP, the F1-c interface is between the gNB-CU-CP and gNB-DU nodes (see References [R07] and [R10].) However, for purposes of O-RAN, the F1-c interface is adopted between the O-CU-CP 221 with the O-DU 215 functions while reusing the principles and protocol stack defined by 3GPP and the definition of interoperability profile specifications.

The F1-u interface connects the O-CU-UP 222 with the O-DU 215. As defined by 3GPP, the F1-u interface is between the gNB-CU-UP and gNB-DU nodes (see References [R07] and [R10]). However, for purposes of O-RAN, the F1-u interface is adopted between the O-CU-UP 222 with the O-DU 215 functions while reusing the principles and protocol stack defined by 3GPP and the definition of interoperability profile specifications.

The NG-c interface is defined by 3GPP as an interface between the gNB-CU-CP and the AMF in the 5GC (see Reference [R06]). The NG-c is also referred as the N2 interface (see Reference [R06]). The NG-u interface is defined by 3GPP, as an interface between the gNB-CU-UP and the UPF in the 5GC (see Reference [R06]). The NG-u interface is referred as the N3 interface (see Reference [R06]). In O-RAN, NG-c and NG-u protocol stacks defined by 3GPP are reused and may be adapted for O-RAN purposes.

The X2-c interface is defined in 3GPP for transmitting control plane information between eNBs or between eNB and en-gNB in EN-DC. The X2-u interface is defined in 3GPP for transmitting user plane information between eNBs or between eNB and en-gNB in EN-DC (see e.g., [O05], [O06]). In O-RAN, X2-c and X2-u protocol stacks defined by 3GPP are reused and may be adapted for O-RAN purposes.

The Xn-c interface is defined in 3GPP for transmitting control plane information between gNBs, ng-eNBs, or between an ng-eNB and gNB. The Xn-u interface is defined in 3GPP for transmitting user plane information between gNBs, ng-eNBs, or between ng-eNB and gNB (see e.g., References [R06] and [R08]). In O-RAN, Xn-c and Xn-u protocol stacks defined by 3GPP are reused and may be adapted for O-RAN purposes

The E1 interface is defined by 3GPP as being an interface between the gNB-CU-CP (e.g., gNB-CU-CP 3728) and gNB-CU-UP (see e.g., [O07], [O09]). In O-RAN, E1 protocol stacks defined by 3GPP are reused and adapted as being an interface between the O-CU-CP 221 and the O-CU-UP 222 functions.

The O-RAN Non-Real Time (RT) RAN Intelligent Controller (RIC) 212 is a logical function within the SMO framework 102, 202 that enables non-real-time control and optimization of RAN elements and resources; AI/machine learning (ML) workflow(s) including model training, inferences, and updates; and policy-based guidance of applications/features in the Near-RT RIC 214.

The O-RAN near-RT RIC 214 is a logical function that enables near-real-time control and optimization of RAN elements and resources via fine-grained data collection and actions over the E2 interface. The near-RT RIC 214 may include one or more AI/ML workflows including model training, inferences, and updates.

The non-RT RIC 212 can be an ML training host to host the training of one or more ML models. The ML data can be collected from one or more of the following: the Near-RT RIC 214, O-CU-CP 221, O-CU-UP 222, O-DU 215, O-RU 216, external enrichment source 110 of FIG. 1, and so forth. For supervised learning, and the ML training host and/or ML inference host/actor can be part of the non-RT RIC 212 and/or the near-RT RIC 214. For unsupervised learning, the ML training host and ML inference host/actor can be part of the non-RT RIC 212 and/or the near-RT RIC 214. For reinforcement learning, the ML training host and ML inference host/actor are co-located as part of the near-RT RIC 214. In some implementations, the non-RT RIC 212 may request or trigger ML model training in the training hosts regardless of where the model is deployed and executed. ML models may be trained and not currently deployed.

In some implementations, the non-RT RIC 212 provides a query-able catalog for an ML designer/developer to publish/install trained ML models (e.g., executable software components). In these implementations, the non-RT RIC 212 may provide discovery mechanism if a particular ML model can be executed in a target ML inference host, and what number and type of ML models can be executed in the target ML inference host. The Near-RT RIC 214 is a managed function (MF). For example, there may be three types of ML catalogs made discoverable by the non-RT RIC 212: a design-time catalog (e.g., residing outside the non-RT RIC 212 and hosted by some other ML platform(s)), a training/deployment-time catalog (e.g., residing inside the non-RT RIC 212), and a run-time catalog (e.g., residing inside the non-RT RIC 212). The non-RT RIC 212 supports necessary capabilities for ML model inference in support of ML assisted solutions running in the non-RT RIC 212 or some other ML inference host. These capabilities enable executable software to be installed such as VMs, containers, etc. The non-RT RIC 212 may also include and/or operate one or more ML engines, which are packaged software executable libraries that provide methods, routines, data types, etc., used to run ML models. The non-RT RIC 212 may also implement policies to switch and activate ML model instances under different operating conditions.

The non-RT RIC 22 is able to access feedback data (e.g., FM, PM, and network KPI statistics) over the O1 interface on ML model performance and perform necessary evaluations. If the ML model fails during runtime, an alarm can be generated as feedback to the non-RT RIC 212. How well the ML model is performing in terms of prediction accuracy or other operating statistics it produces can also be sent to the non-RT RIC 212 over O1. The non-RT RIC 212 can also scale ML model instances running in a target MF over the O1 interface by observing resource utilization in MF. The environment where the ML model instance is running (e.g., the MF) monitors resource utilization of the running ML model. This can be done, for example, using an ORAN-SC component called ResourceMonitor in the near-RT RIC 214 and/or in the non-RT RIC 212, which continuously monitors resource utilization. If resources are low or fall below a certain threshold, the runtime environment in the near-RT RIC 214 and/or the non-RT RIC 212 provides a scaling mechanism to add more ML instances. The scaling mechanism may include a scaling factor such as a number, percentage, and/or other like data used to scale up/down the number of ML instances. ML model instances running in the target ML inference hosts may be automatically scaled by observing resource utilization in the MF. For example, the Kubernetes® (K8s) runtime environment typically provides an auto-scaling feature.

The A1 interface is between the non-RT RIC 212, which is within—the SMO 202) and the near-RT RIC 214. The A1 interface supports three types of services as defined in Reference [R14], including a Policy Management Service, an Enrichment Information Service, and ML Model Management Service. A1 policies have the following characteristics compared to persistent configuration as defined in Reference [R14]: A1 policies are not critical to traffic; A1 policies have temporary validity; A1 policies may handle individual UE or dynamically defined groups of UEs; A1 policies act within and take precedence over the configuration; and A1 policies are non-persistent, i.e., do not survive a restart of the near-RT RIC.

FIG. 3 illustrates services of the A1 interface 300, in accordance with some embodiments. The services of the A1 interface 300 include A1 policy service (A1-P) 316, A1 AI/ML model management service (A1-ML) 318, and A1 enrichment information (EI) service (A1-EI) 320. One Non-RT RIC 212 can connect to multiple Near-RT RICs 214. The reference [R03] describes A1-P 316, A1-ML 318, and EI 320, between the Non-RT RIC 212 and the Near-RT RIC 214 for RAN optimization and operation. The Non-RT RIC 212 includes A1-P consumer 304, A1-ML consumer 306. A1-EI producer 306, A1-P producer 310, A1-ML producer 312, and A1-EI consumer 314.

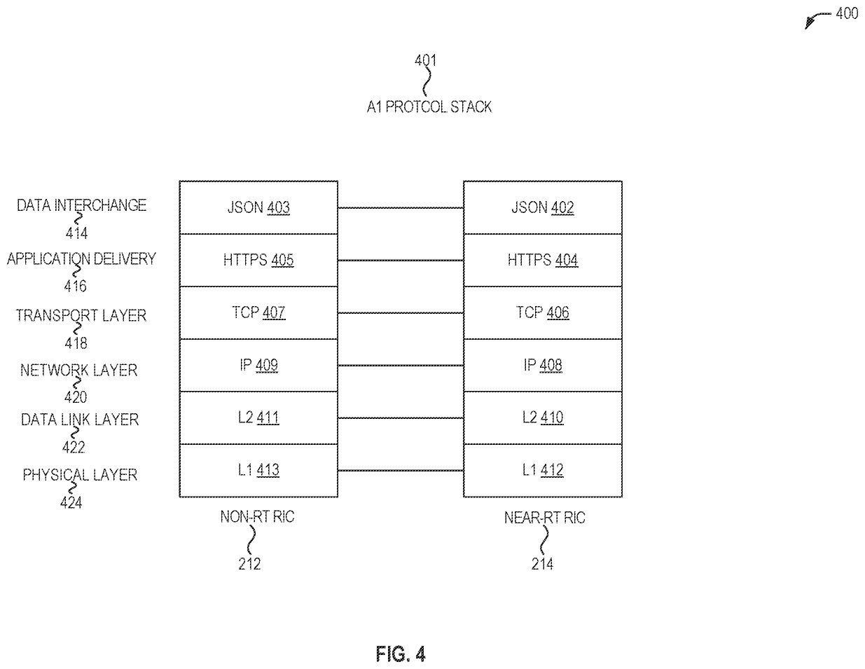

FIG. 4 illustrates the protocol stack of the A1 interface 400, in accordance with some embodiments. The A1 protocol stack 401 includes for Non-RT RIC 212 and Near-RT RIC 214, respectively, the following: data interchange 414, JSON 403, 402; application delivery 416, HTTPS 405, 404; transport layer 418, TCP 407, 406; network layer 420, IP 409, 408; data link layer 422, L2 411, 412; and physical layer 424, L1 413, 412.

The application layer protocol is based on a RESTful approach with JSON 402, 403 for data interchange 414. The references [R03] and [R04] provide details regarding A1-P 316.

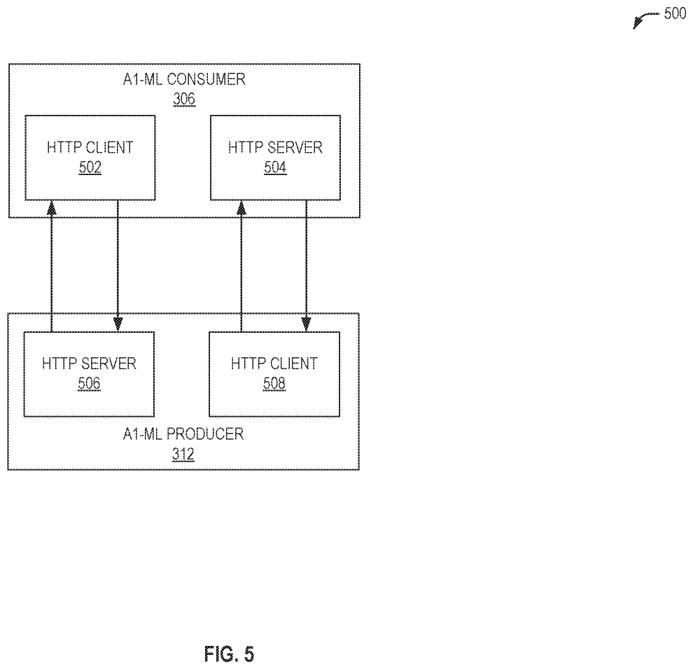

FIG. 5 illustrates HTTP roles in A1-ML service framework 500, in accordance with some embodiments. FIG. 5 illustrates an A1-ML service description and operations for federated learning (FL) between Non-RT RIC and Near-RT RICs. A1-ML is based on signaling between A1-ML consumer 306 in the Non-RT RIC 212 and the A1-ML producer 312 in Near-RT RIC 214. The A1-ML consumer 306 is configured to send requests to and get responses from the A1-ML producer 312. The A1-ML consumer 306 is configured to subscribe to notifications from A1-ML producer 312. In one embodiment, A1-ML consumer 306 and A1-ML producer 312 both use HTTP operations. e.g., HTTP client 502, HTTP server 504, HTTP server 506, and HTTP client 508.

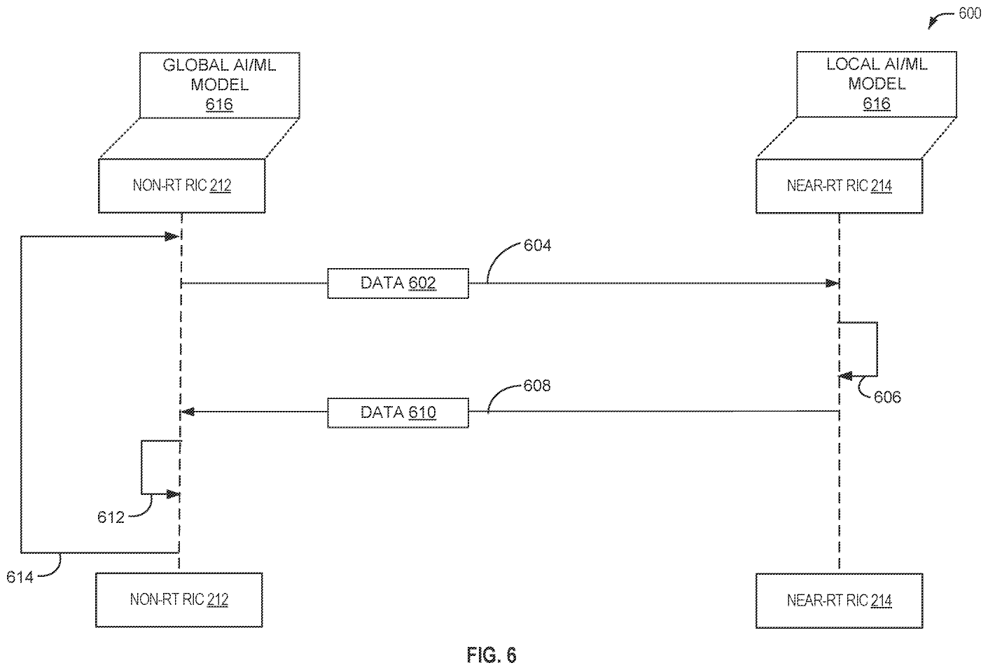

FIG. 6 illustrates a method 600 for federated learning between the Non-RT RIC and the Near-RT RIC, in accordance with some embodiments. The Non-RT RIC 212 is configured to act as the central server in the federated learning, and the Near-RT RICs 214 that are connected to the Non-RT RIC 212 are clients of the Non-RT RIC 212. A global AV/ML model 616 for Federated Learning (FL) is maintained in the Non-RT RIC 212 (or A1-ML consumer 306), and each Near-RT RIC 214 (or A1-ML producer 312) has a local AI/ML model 616.

The method 600 begins at operation 604 with the Non-RT RIC 212 sending a global model download that includes data 602. The data 602 may include the global AI/ML model 616.

The method 600 continues at operation 606 with the Near-RT RIC 214 updating the local AI/ML model 616, which may be initially a copy of the global AI/ML model 616, or the local AI/ML model 616 may be updated based on the received global AI/ML 616. The Near-RT RIC 214 receives the global AI/ML model 616 and trains the received the global AI/ML model 616 using its locally available training data set. The trained global AI/ML model 616 is then regarded as or termed its local model.

The method 600 continues at operation 610, which includes data 610, with the Near-RT RIC 214 uploading the local AI/ML model 616 to the Non-RT RIC 212. The data 610 may include the local AI/ML model 616, a portion of the AI/ML model 616, or the gradients for model updates.

The method 600 continues at operation 612 with the non-RT RIC 212 updating the global AI/ML model 616 based on the received data 610, which include the local AI/ML model 616 or the gradients. The method 600 may include operation 614 where the method 600 iterates until a termination criteria is met for the training such as error thresholds or changes to weights being below a threshold.

The method 600 is described with one Near-RT RIC 214 but there many be more than one Near-RT RIC 214 interacting with the Non-RT RIC 212. The O-RAN uses O1 interface for deployment of a trained and tested ML model from the Non-RT RIC 212 to the Near-RT RIC 214. However, the model updates in FL may not be the full AI/ML model transmission. Exchanges between FL clients, e.g., Near-RT RIC 214, and the central server, e.g., the Non-RT RIC 212, can be portions, gradients, or compressed AI/ML models.

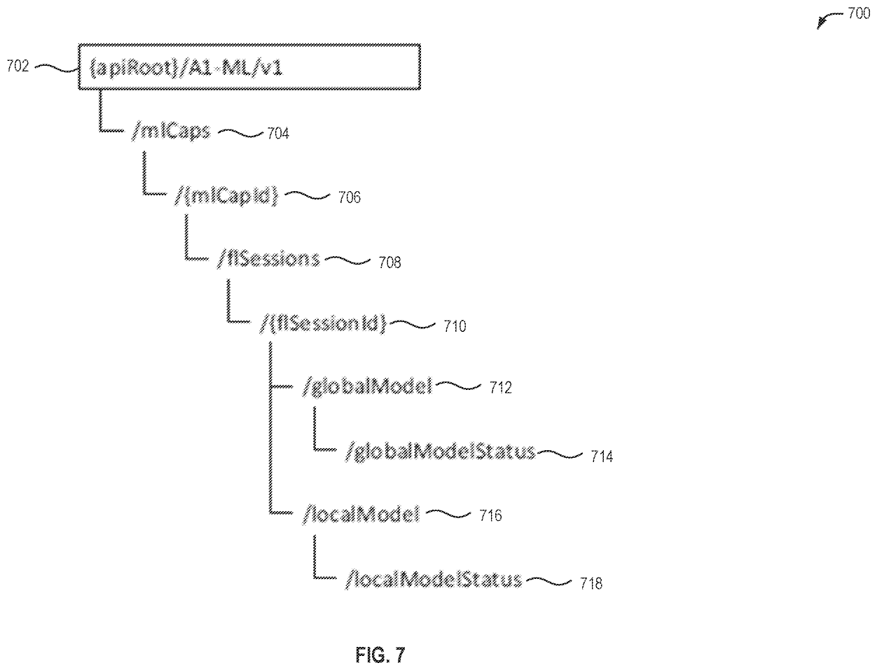

FIG. 7 illustrates an AI/ML API resource uniform resource identifier (URI) 700, in accordance with some embodiments. The root is identified as ({apiRoot}/A1-ML/v1) 702. The Near-RT RIC 214 identifies its capability of A1-ML services through the ML capabilities (mlCaps) 704, which is for a JSON resource. A ML capability (mlCaps) 704 is identified by a ML capability identifier (/{mlCapid}) 706. If the Near-RT RIC 214 supports FL, a FL session can be setup between Non-RT RIC 212 and Near-RT RIC 214, and the session is identified by its unique FL session ID, e.g., (/flSessions) 708, (/flSession ID) 710.

A FL session object consists of a global model (/globalModel) 712 and a local model (/localModel) 714. Models are identified by their IDs and a model resource object specifies the format of the model updates (model update or gradient update), the content of the model update, and the status of the model (/globalModelStatus) 716 or (/localModelStatus) 718. The status of a model indicates whether the model needs to be updated. Table 1 describes the

TABLE 1
Definitions of IDs

| Type Name | Type Definition | Description |
|---|---|---|
| MLCapId | String | ML Capability identifier |
| FLSessionId | String | Federated Learning session |
| | | identifier assigned by Non-RT |
| | | RIC |

In some embodiments, JSON objects are used. In one embodiment, the following JSON objects are used in the service operation of the A1-ML service for FL. FLSessionObject: The FL session object is the JSON representation of a FL session. A FL session is identified by its unique session ID, which is assigned by Non-RT RIC 212. A FL session links a global model and a local model for federated learning. GlobalModelObject: The global model object is the JSON representation of the global model in the FL. In one embodiment, the GlobalModelObject is defined as described in Table 2. The global model object acts as a notification to the Near-RT RIC 214 that the model file is ready. The model file may be transferred using FTP, FTPeS, or SFTP, or another transfer protocol.

TABLE 2
Global Model Object

| Attribute Name | Data Type | P | Cardinality | Description |
|---|---|---|---|---|
| modelId | number | M | 1 | Model ID for the |
| | | | | global model, |
| | | | | unique in Non- |
| | | | | RT RIC. |
| modelUpdateType | Model- | M | 1 | Tyep of model |
| | UpdateType | | | update, including |
| | | | | gradient and |
| | | | | compressed model. |
| modelFileLocation | string | M | 1 | Model update file |
| | | | | location. |
| modelFileSize | Number | M | 1 | Model update file |
| | | | | encoding method. |
| modelFileFormat | string | M | 1 | Model update file |
| | | | | encoding method.. |
| modelFileCompression | string | O | 0 . . . 1 | Model update file |
| | | | | compression |
| | | | | algorithm. |
| modelExpirationTimer | string | O | 0 . . . 1 | If the model |
| | | | | does not get |
| | | | | updated before |
| | | | | the timer expires, |
| | | | | then the Near-RT |
| | | | | RIC generates a |
| | | | | notification to the |
| | | | | Non-RT RIC to |
| | | | | request a global |
| | | | | model update. |

In one embodiment, the ModelUpdateType has the enumeration as described in Table 3.

TABLE 3
Model Update Type

| Enumeration Value | Description |
|---|---|
| Gradient | The update model file contains the |
| | gradient for model update. |
| Compressed_Model | The update model file contains a |
| | compressed model for model update. |

The GlobalModelStatusObject is the status object of the global model and is the JSON representation indicating whether the model is timely updated. Table 4 is an enumeration of the GlobalModelStatusObject, in accordance with some embodiments.

TABLE 4
Global Model Status Object

| Attribute Name | Data Type | P | Cardinality | Description |
|---|---|---|---|---|
| timeStamp | String | M | 1 | Time stamp |
| | | | | of the last |
| | | | | model |
| | | | | update. |
| NotificationReason | GM- | C | 0 . . . 1 | Reason for |
| | Notificaiton- | | | this |
| | ReasonType | | | notification. |

In one embodiment the GMNotificationReasonType has the enumeration as described in Table 5.

TABLE 5
GMNotificationReasonType

| Enumeration Value | Description |
|---|---|
| Timer_expire | The update timer expires, and there is |
| | no global model update from the |
| | Non-RT RIC |
| ID_Error | The model ID does not match. |
| Other_reason | Other reasons. |

The local model object, e.g., LocalModelObject, is the JSON representation of the local model in the FL. The local model object acts as a notification to the Near-RT RIC 214 that the model file is ready. The model file is transferred to the Non-RT RIC 212 using FTP, FTPeS, or SFTP, or another transfer protocol. The local model object may have an enumeration as described in Table 6.

TABLE 6
Local Model Object

| Attribute Name | Data Type | P | Cardinality | Description |
|---|---|---|---|---|
| modelID | Number | M | 1 | Model ID for |
| | | | | the local |
| | | | | model, which |
| | | | | may be unique |
| | | | | in Near-RT |
| | | | | RIC |
| modelUpdateType | Model- | M | 1 | Type of model |
| | UpdateType | | | update, |
| | | | | including |
| | | | | gradient and |
| | | | | compressed |
| | | | | model. |
| modelFileLocation | String | M | 1 | Model update |
| | | | | file location. |
| modelFileSize | Number | M | 1 | Model update |
| | | | | file size. |
| ModelFileSize | Number | M | 1 | Model update |
| | | | | file size. |
| modelFileFormate | String | M | 1 | Model update |
| | | | | file encoding |
| | | | | method. |
| modelFileCompression | String | O | 0 . . . 1 | Model update |
| | | | | file |
| | | | | compression |
| | | | | method. |

The local model status object, e.g., LocalModelStatusObject, of the local model may be a JSON representation indicating whether the model is timely updated. Table 7 is an enumeration of the local model status object.

TABLE 7
Local model status object

| Attribute Name | Data Type | P | Cardinality | Description |
|---|---|---|---|---|
| timeStamp | String | M | 1 | Time stamp |
| | | | | of the last |
| | | | | model |
| | | | | update. |
| notificationReason | LMNotification- | C | 0 . . . 1 | Reason for |
| | ReasonType | | | this |
| | | | | notification. |

In one embodiment the local model (LM) notification reason type, e.g., LMNotificationReasonType, an enumeration as described in Table 8.

TABLE 8
LMNotificationReasonType

| Enumeration Value | Description |
|---|---|
| Model_Update_Available | A new local model update is available |
| | in Near-RT RIC |
| ID_Error | The model ID does not match. |
| Model_Terminated | The local model is terminated. |
| Other_Reason | Other Reason. |

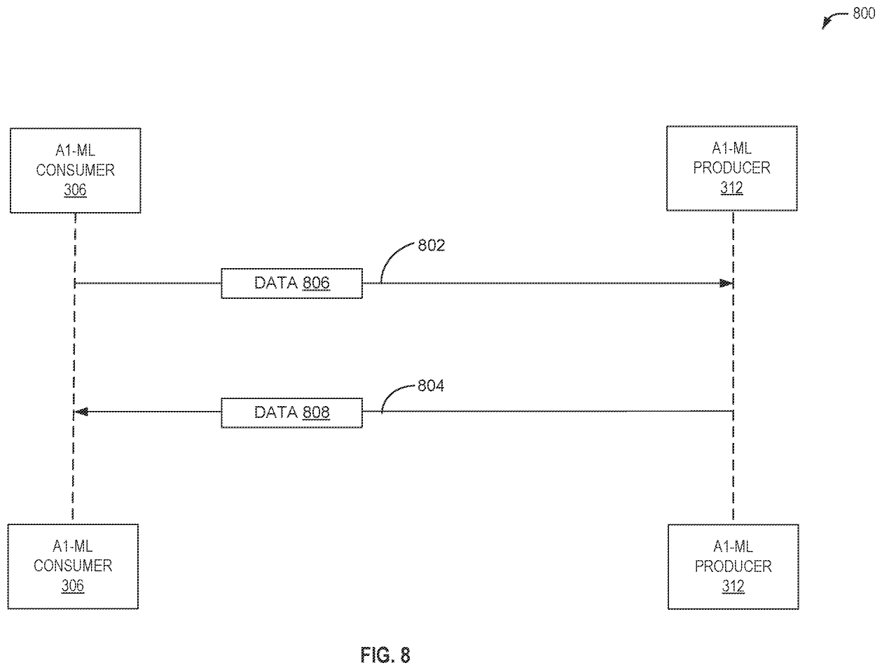

FIG. 8 illustrates a method 80 for querying ML capability, in accordance with some embodiments. The method 800 begins at operation 802 with the A1-ML consumer 306 of the non-RT RIC 212 sending a “get . . . /mlCaps” query with data 806. The data 806 is the query for ML capabilities (Caps).

The ML capabilities query queries the A1-ML producer 312 of the Near-RT RIC 214 for the capabilities of the A1-ML services of the Near-RT RIC 214. The Non-RT RIC 212 can query for all supported ML capabilities in the Near-RT RICs. or it can query a specific ML capability (e.g., support of FL). The A1-ML consumer 306 uses HTTP GET request, in some embodiments, to solicit a get response from A1-ML producer 312.

The method 800 continues at operation 804 with the A1-ML producer 312 sending an HTTP response of “200 OK (array(mlCapID))” message with data 808. The data 808 is the message “200 OK (array(mlCapID))”, in accordance with some embodiments. The data 808 includes for a query of all ML capabilities an array of the ML capability identifiers supported by the Near-RT RIC 214.

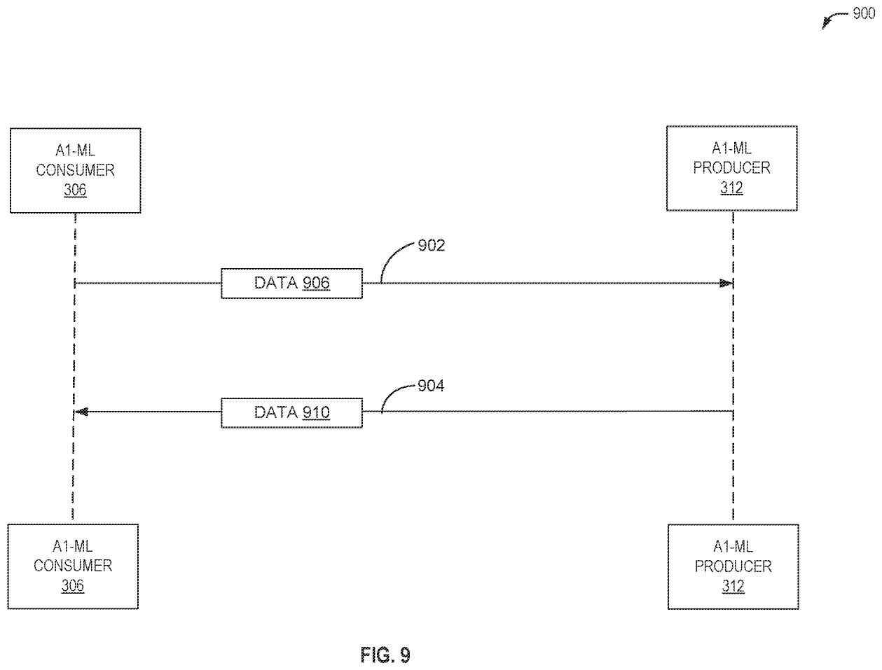

FIG. 9 illustrates a method 900 for querying for a specific ML capability, in accordance with some embodiments. The method 900 begins at operation 902 with the A1-ML consumer 306 of the non-RT RIC 212 sending a “get . . . /mlCaps/{mlCapid}” query with data 906. The data 906 is the query for ML capabilities (Caps), which here is for a specific ML capability with the capabilities ID (mlCapid).

The ML capabilities query queries the A1-ML producer 312 of the Near-RT RIC 214 for a specific ML capability of the A1-ML services of the Near-RT RIC 214. The A1-ML consumer 306 uses HTTP GET request, in some embodiments, to solicit a get response from A1-ML producer 312.

The method 900 continues at operation 904 with the A1-ML producer 312 sending an HTTP response of “200 OK (array(mlCapObject))” message with data 910. The data 910 is the message “200 OK (array(mlCapObject))”, in accordance with some embodiments. The data 910 includes for a query of specific ML capability a ML capabilities object (mlCapObject) that identifies the requested capabilities. The data 910 of the HTTP response (operation 904) for a query of a single ML category contains the JSON resource object of indicated ML capability object.

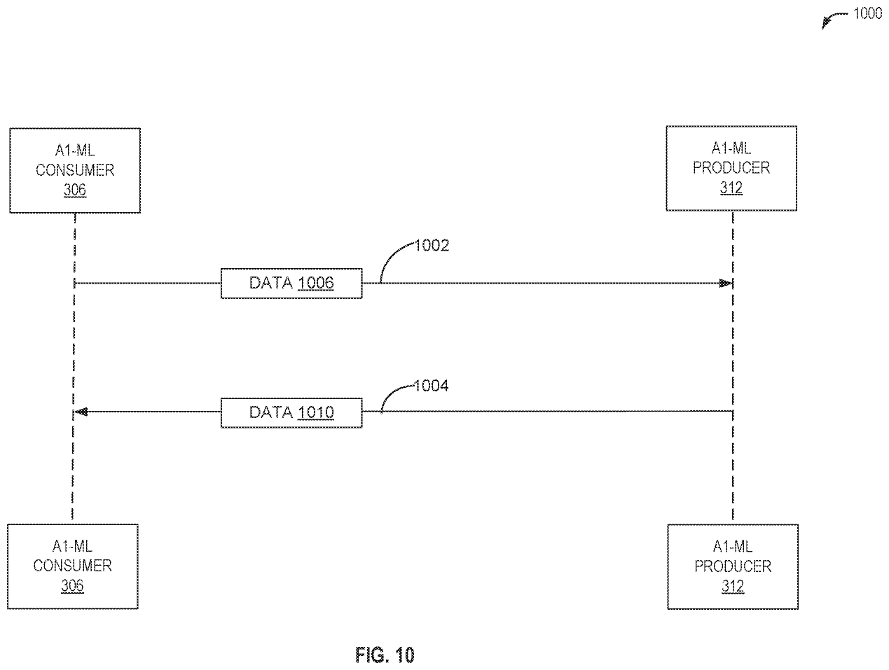

FIG. 10 illustrates a method 1000 for creating a FL session, in accordance with some embodiments. The method 1000 begins at operation 1002 with the A1-ML consumer 306 sending a put request with data 1006. The data 1006 may be “put . . . mlCaps/(mlCapid)/flSessions/ . . . (flSessionID)(FLSesssionObject)”.

The A1-ML consumer 306 of the Non-RT RIC 212 sends a HTTP PUT request (operation 1002) to the A1-ML producer 312 of the Near-RT RIC 214 to set up a session for FL between a global model in the Non-RT RIC 212 and a local model in the Near-RT RIC 214 for FL. The PUT request message, e.g., data 1006, includes a FL session object.

The method 1000 continues at operation 1004 with the A1-ML producer 312 responding with an HTTP response code “201” if the creation is success. Operation 1004 includes data 1010, which may include “201 created (FLSesssionObject)”. This method 1000 links the global and local models for FL.

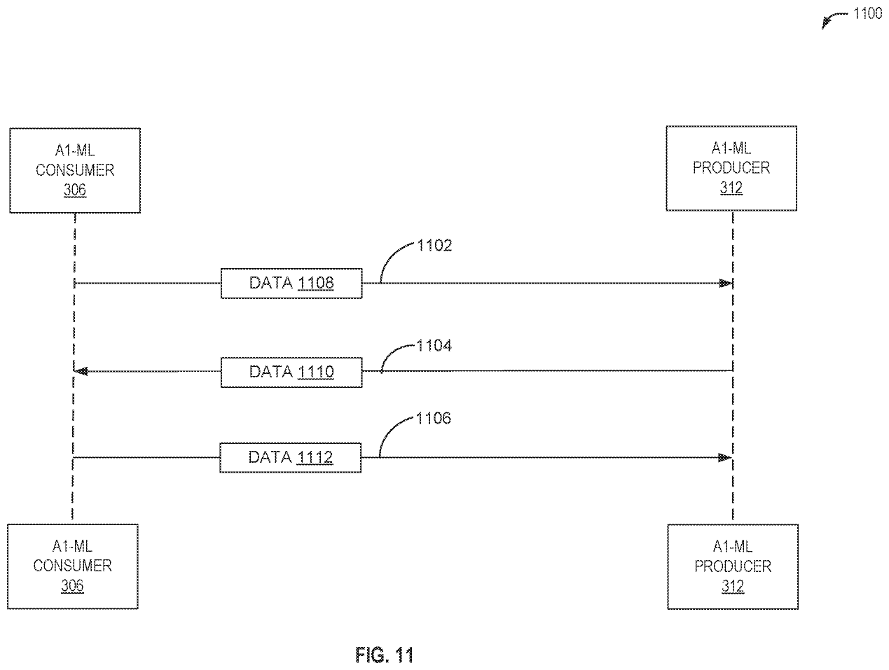

FIG. 11 illustrates a method 1100 of downloading a global model, in accordance with some embodiments. The method 1110 begins at operation 1102 with the A1-ML consumer 306 sending a put request to the A1-ML producer 312. The operation 1102 includes data 1108, which may be “Put . . . mlCaps/{mlCapId}/flSessions/{flSessionID}/globalModel (GlobalModelObject)”. The method 1100 enables the Non-RT RIC 212 to download or update the global model of a specific FL session in the Near-RT RIC 214. The PUT request message, operation 1102, carries the model object for the global model download/update. The model object indicates whether the model update is a gradient or a compressed model. It also contains information for file transfer, e.g., file location (URL), file size, encoding schemes, expiration timer, and so forth. The model file is transferred using FTP, SFTP, or another transfer protocol.

The method 1100 continues at operation 1104 with “200 OK”, which includes data 1110. The data 1110 may includes the message “200 OK (GlobalModelObject).” The A1-ML producer 312 response is HTTP response code “200” if the GlobalModelObject is successfully received.

The method 1100 continues at operation 1106 with data 1112 with <FTP or SFTP> model file transfer where the A1-ML consumer 306 transfers the model to the A1-ML producer 312.

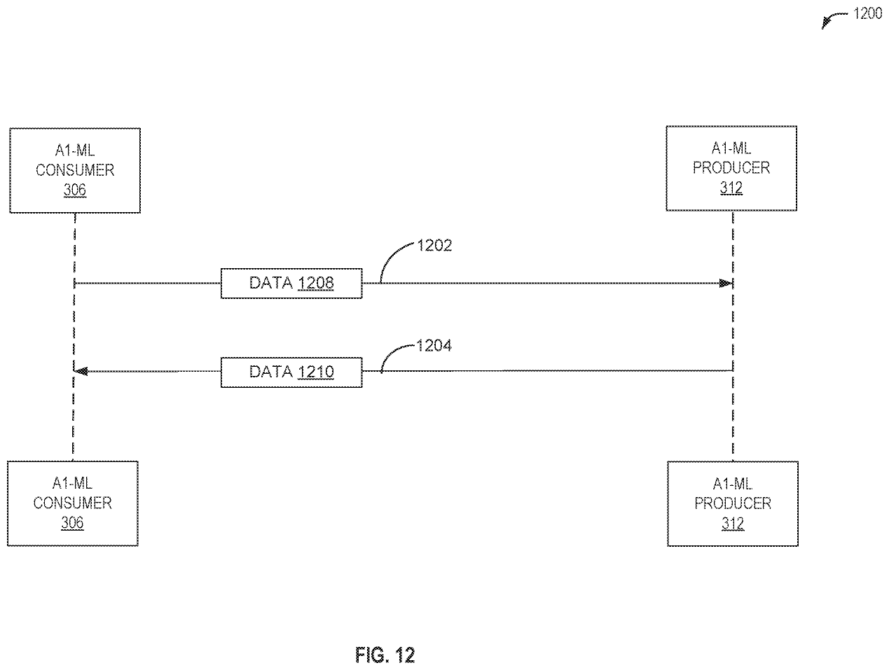

FIG. 12 illustrates a method 1200 for querying the global model status, in accordance with some embodiments. The method 1200 begins at operation 1202 with a “get” request message that includes data 1208. The data 1208 may be the “get . . . .

mlCaps/{mlCapId}/flSessions/{flSessionID}/globalModel/status” message. This operation 1202 is used to query the status of the global model in a FL session. The GET request message body is empty.

The method 1200 continues at operation 1204 with the A1-ML producer 312 responding with HTTP response code “200” with the model status object for the global model in the message body. The data 1210 is the HTTP response with the model status.

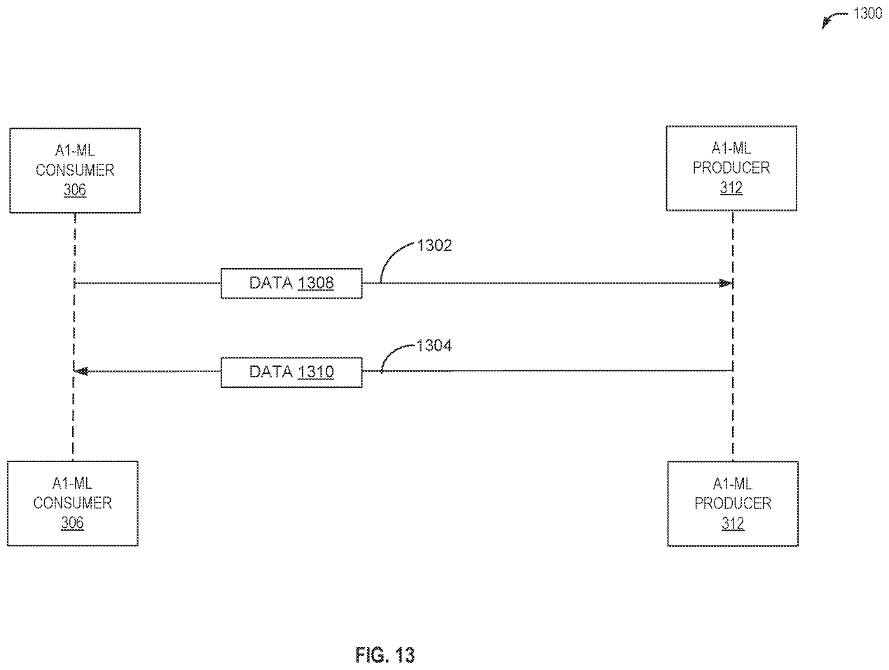

FIG. 13 illustrates a method 1300 for querying the local model status, in accordance with some embodiments. The method 1300 begins at operation 1302 with the A1-ML consumer 306 sending a “get” request message such as “mlCaps/{mlCapId}/flSessions/{flSessionID}/localModel/status.” The data 1308 is the “get” request message and accompanying data. The “get” operation 1302 is used by the Non-RT RIC 212 to query the status of the local model in Near-RT RIC 214.

The method 1300 continues at operation 1304 with the A1-ML producer 312 responding with data 1310. If the status object indicates that there is an available update for the local model in the Near-RT RIC 214, then Non-RT RIC 212 can initiate a local model upload procedure which is defined below. The GET request message body is empty, e.g., the data 1308 is only the get request message. The A1-ML producer 312 responds with operation 1304, which may be “HTTP response code ‘200’” with the status object for local model in the message body, e.g., data 1310.

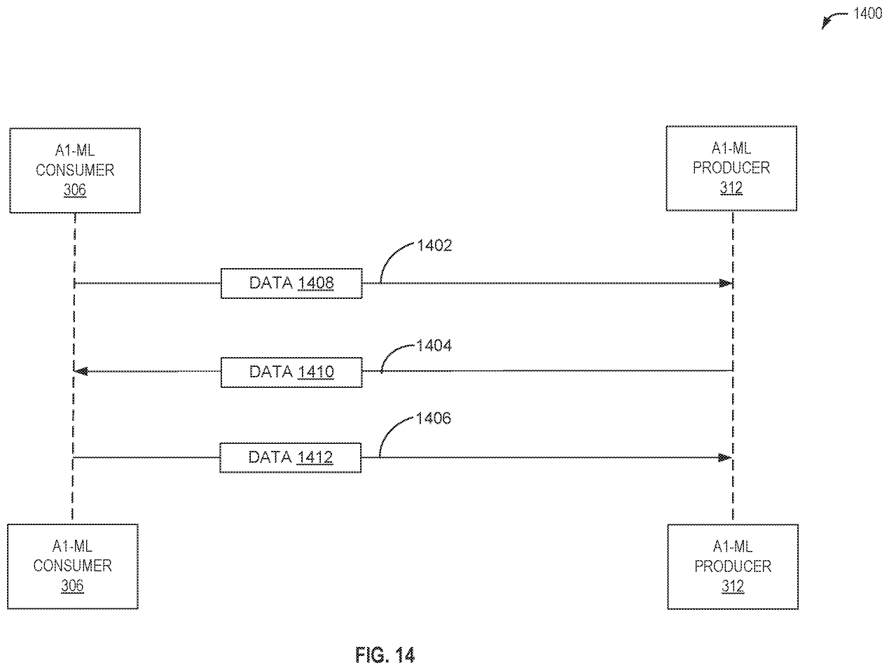

FIG. 14 illustrates a method 1400 for uploading local models, in accordance with some embodiments. The method 1400 begins at operation 1402 with a Get request message. The data 1408 is the get request message where the body may be empty. Based on the outcome of the query of FIG. 13, the Non-RT RIC 212 can request an update on the local model from Near-RT RIC 214.

The method 1400 continues at operation 1404 with the A1-ML producer 312 responding with an OK response with data 1410. The data 1410 is the HTTP response with code “200” and the local model object in the message body. The model object indicates the model update type (gradient or compressed model). The model object also contains information such as file location (URL), file size, encoding schemes, so that Non-RT RIC 212 can upload/update the model from Near-RT RIC 214. The method 1400 continues at operation 1406 including data 1412. The data 1412 is the model file being transferred using FTP, SFTP, or another file transfer protocol.

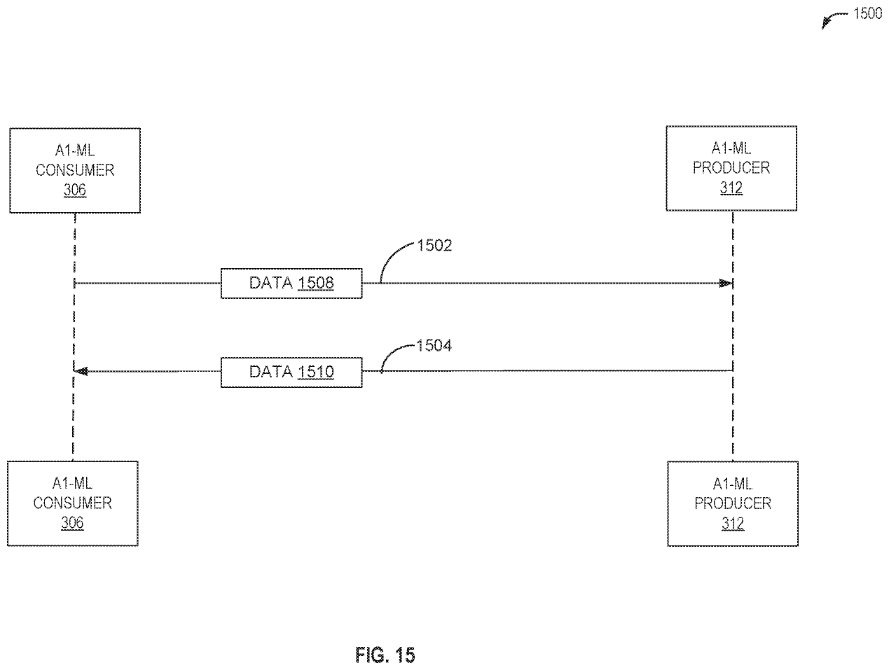

FIG. 15 illustrates a method 1500 of deleting the FL session, in accordance with some embodiments. The method 1500 begins at operation 1502 with sending a delete request. The operation 1502 includes data 1508 which is the delete request, which may be “DELETE mlCaps/{mlCapId}/flSessions/{flSessionID}”. The body of the delete message may be empty. Operation 1502 is a request or command to delete a FL session identified by “flSessionID”.

The method 1500 continues with operation 1504 with the A1-ML producer 214 responding with an HTTP response code “204” with an empty message body, if the procedure is success. Operation 1504 includes data 1510 which is the response message to operation 1502.

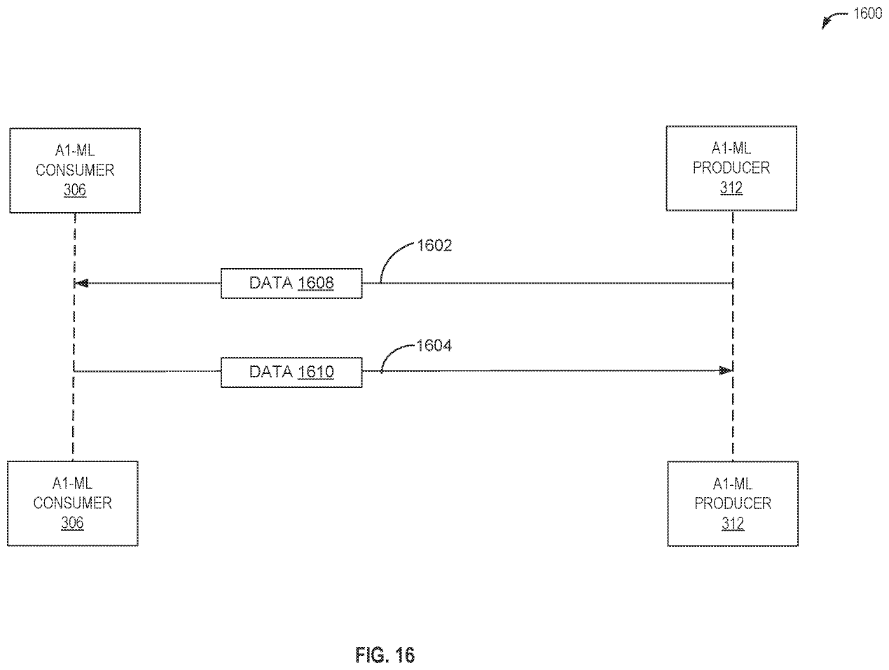

FIG. 16 illustrates a method 1600 of notifying the global model status, in accordance with some embodiments. The method 1600 begins at operation 1602 with a post request that includes data 1608. The data 1608 includes the post request. Operation 1602 enables the Near-RT RIC 214 to notify the Non-RT RIC 212 that it has not received an update for the global model in a FL session for a certain period of time, and it can be followed by a global model download procedure. The post request may include “POST {notificationDestination}(GlobalModelStatusObject)”.

The POST request from the Near-RT RIC 212 targets the resource URI “notificationDestination”, which is the URI query parameter given during the creation of the FL session. The message body of the post request contains a status object for the global model. The method 1600 continues with the A1-ML consumer 306 responding at operation 1604 with an HTTP response code “204” with empty message body. The data 1610 is the HTTP response.

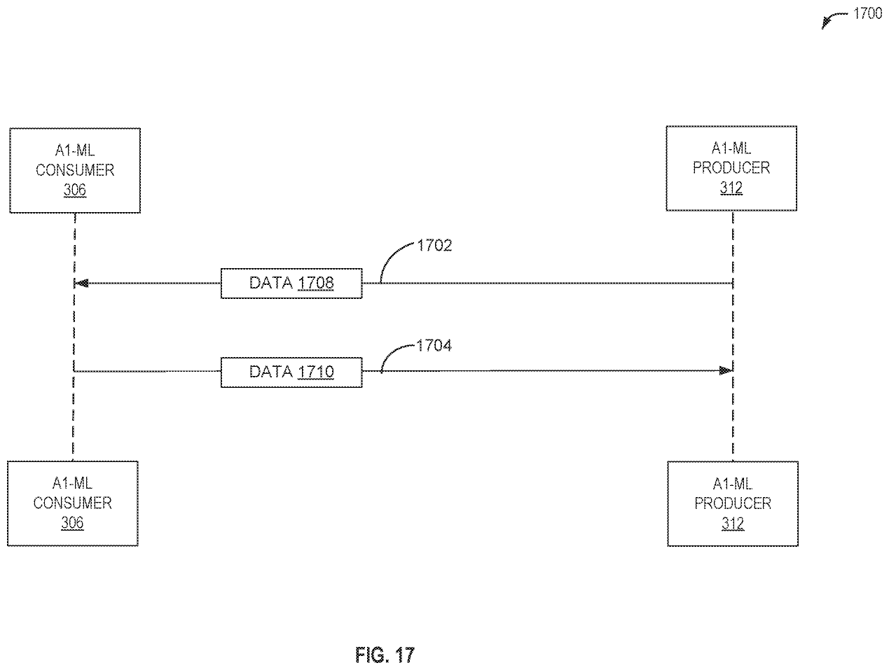

FIG. 17 illustrates a method 1700 to notify of a local model status, in accordance with some embodiments. This method enables the Near-RT RIC 214 to notify the Non-RT RIC 212 that it has new version of local model in a FL session and the method 1700 can be followed by a local model upload procedure. The method 1700 begins at operation 1702 with a post message that includes data 1708. The data 1708 is the post message which may be “POST {notificationDestination} (LocalModelStatusObject).” The message body contains a status object for the local model. The A1-ML consumer 306 responds at operation 1704 with sending an HTTP response code “204” with an empty message body. Operation 1704 includes data 1710 which is the HTTP response.

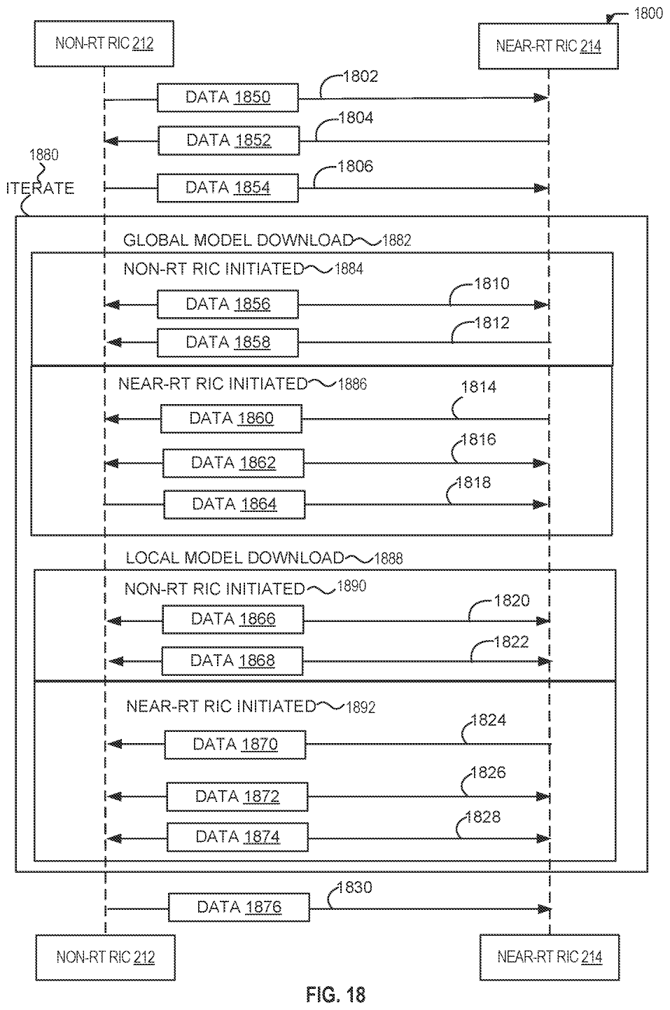

FIG. 18 illustrates a method for federated learning between a Non-RT RIC and Near-RT RICs, in accordance with some embodiments. The method 1800 is for FL between Non-RT RIC and Near-RT RIC.

The method 1800 begins at operation 1802 with query ML capability with data 1850. For example, this may be the same or similar as operation 802.

The method 1800 continues at operation 1804 with sending the support of FL with data 1852. For example, this may be the same or similar as operation 804. The method 1800 continues at operation 1806 with creating FL session with data 1854. The non-RT RIC 212 creates the FL session as described herein.

The method 1800 continues at operation 1882 with the global model being downloaded. The global model may be downloaded based on the Non-RT RIC initiated 1884 download or the Near-RT RIC initiated download 1886.

For the Non-RT RIC initiated 1884 download, the method 1800 begins at operation 1810 with data 1856 where, optionally, the Near-RT RIC 214 and/or the Non-RT RIC 212 query one another regarding the global model status. For example, operation 1202 is an example of a query the status of the global model.

The method 1800 continues at operation 1812 with data 1858 with the global model being downloaded. For example, method 1100 provides a method to download the global model.

The global model download includes two options Non-RT RIC initiated 1884 and Near-RT RIC initiated 1886. The Near-RT RIC initiated 1886 includes operations 1814, 1816, and 1818.

The method 1800 continues with the Near-RT RIC initiated 1886 download of the global model. The Near-RT RIC initiated 1886 method 1800 begins at operation 1814 with sending a message of notifying the global model status, which is included in data 1860. For example, method 1200 illustrates a method 1200 for querying global model status. The method 1800 continues at operation 1816 with sending a message to query global model status, which is included in the data 1862. The method 1800 continues at operation 1818 with downloading the global model, which is included in the data 1864. For example, method 1200 illustrates a method 1200 for querying global model status.

The method 1800 includes a local model download 1888, which may be Non-RT RIC initiated 1890 or Near-RT RIC initiated 1892. The Non-RT RIC initiated 1890 comprises the following two operations. The method 1800 begins, optionally, at operation 1820 with sending a message to query local model status, which is included in the data 1866. The method 1800 continues at operation 1822 with sending a message to local model upload, which is included in data 1868. Method 1300 provides a method for querying a local model status. Method 1300 provides a method for uploading or updating a local model.

The method 1800 includes the Near-RT RIC initiated 1892 local model upload. The Near-RT RIC initiated 1892 local model upload begins at operation 1824 with sending a message to notify local model status, which is included in data 1870. The method 1800 continues, optionally, at operation 1826 with send a query for local model status, which is included in data 1872. Method 1700 provides a method for notifying local model status. Method 1400 provides a method for upload/update a local model. Method 1200 provides a method for query a local model status.

The method 1800 continues at operation 1830 with sending a message to delete (or notify of deletion of) FL session, which is included in data 1876. Method 1400 provides a method for deleting a FL session.

The methods described in conjunction with FIGS. 3-18 may include one or more additional operations. The operations of the methods described in conjunction with FIGS. 3-18 may be performed in a different order. One or more of the operations of the methods described in conjunction with FIGS. 3-18 may be optional.

### REFERENCES

[R01] O-RAN WG1, “O-RAN Architecture Description.”
[R02] O-RAN WG2, “AI/ML Workflow Description and Requirements”.
[R03] O-RAN WG2, “A1 interface: General Aspects and Principles.”
[R04] O-RAN WG2, “A1 interface: Application Protocol.”
[R04] 3GPP TS 36.401 v15.1.0 (2019 Jan. 9).
[R05] 3GPP TS 36.420 v15.2.0 (2020 Jan. 9).
[R06] 3GPP TS 38.300 v16.0.0 (2020 Jan. 8).
[R07] 3GPP TS 38.401 v16.0.0 (2020 Jan. 9).
[R08] 3GPP TS 38.420 v15.2.0 (2019 Jan. 8).
[R09] 3GPP TS 38.460 v16.0.0 (2020 Jan. 9).
[R10] 3GPP TS 38.470 v16.0.0 (2020 Jan. 9).
[R12] O-RAN Alliance Working Group 1, O-RAN Operations and Maintenance Architecture Specification, version 2.0 (December 2019) (“O-RAN-WG1.OAM-Architecture-v02.00”).
[R13] O-RAN Alliance Working Group 1, O-RAN Operations and Maintenance Interface Specification, version 2.0 (December 2019) (“O-RAN-WG1.O1-Interface-v02.00”).
[R14] O-RAN Alliance Working Group 2, O-RAN A1 interface: General Aspects and Principles Specification, version 1.0 (October 2019) (“ORAN-WG2.A1.GA&P-v01.00”).
[R15] O-RAN Alliance Working Group 3, Near-Real-time RAN Intelligent Controller Architecture & E2 General Aspects and Principles (“ORAN-WG3.E2GAP.0-v0.1”).
[R16] O-RAN Alliance Working Group 4, O-RAN Fronthaul Management Plane Specification, version 2.0 (July 2019) (“ORAN-WG4.MP.0-v02.00.00”).
[R17] O-RAN Alliance Working Group (WG) 4, O-RAN Fronthaul Control, User and Synchronization Plane Specification, version 2.0 (July 2019) (“ORAN-WG4.CUS.0-v02.00”).
[R18] O-RAN WG1, “O-RAN Architecture Description”.
[R20] O-RAN WG2. “Non-RT RIC Functional Architecture”

### Terminology

The term “application” may refer to a complete and deployable package, environment to achieve a certain function in an operational environment. The term “AI/ML application” or the like may be an application that contains some AI/ML models and application-level descriptions.

The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), decision tree algorithms, support machine vectors. Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

The following describe further examples. Example 1 includes where an A1-ML (A1 machine learning model management service) is used to support federated learning between Non-RT RICs and Near-RT RICs in an O-RAN architecture. In one embodiment, an A1-ML consumer (in Non-RT RIC) and A1-ML producer (in Near-RT RIC) both have a HTTP server and client. A1-ML supports the following service operations: ML capability query; Federated learning session creation; Federated learning session deletion; Global model download/update; Local model upload/update; Global model status query; Local model status query; Global model status notification; and, Local model status notification.

In Example 2, the subject matter of Example 1 optionally includes where Non-RT RIC queries Near-RT RIC's ML capability via A1-ML using HTTP GET method. ML capability is identified by the ML capability identifier.

In Example 3, the subject matter of Examples 1 and 2 optionally includes where a federated learning session includes a global model in Non-RT RIC and a local model in Near-RT RIC. It is identified by a unique session ID, which is assigned by Non-RT RIC.

In Example 4, the subject matter of Examples 1-3 optionally includes where a Non-RT RIC creates the federated learning session (FLSessionObject) via A1-ML using HTTP PUT method. A callback URI (notificationDestination) is provided to Near-RT RIC when a FL session is created. Near-RT RIC uses it for notification posting.

In Example 5, the subject matter of Examples 1-4 optionally includes where a ML model object (global or local) is identified by its model ID. In one embodiment, the object contains a field to indicate the model update type: a model gradient or a compressed model. The model object also includes model file related information, e.g., the location (path or URL) of the model file, the size of the model file, the encoding method of the model file, etc. A global model objection optionally indicates an expiration timer for the following updates. If the times expires, then Near-RT RIC sends notification indicating that an update for global model is missing.

In Example 6, the subject matter of Examples 1-5 optionally includes where Non-RT RIC sends the global model (GlobalModelObject) to Near-RT RIC via A1-ML using HTTP PUT method, which is followed by model file transfer using FTP, SFTP, or FTPeS, etc. Near-RT RIC updates the model accordingly.

In Example 7, the subject matter of Examples 1-6 optionally includes where the Non-RT RIC inquires the status of the global model via A1-ML using HTTP GET method. Near-RT RIC replies with the status (Global Model Status Object), showing the timestamp of most recent model update. Non-RT RIC decides whether a global model download is needed or not.

In Example 8, the subject matter of Examples 1-7 optionally includes where the Near-RT RIC sends a notification (GlobalModelStatusObject) via A1-ML using HTTP POST method. In addition to the update timestamp, the notification includes the reason of sending this notification. In one embodiment, the type of the reason includes: global model not get updated, model id mismatch, etc. Non-RT RIC decides whether it should update the global model.

In Example 9, the subject matter of Examples 1-8 optionally include where the Non-RT RIC inquires the status of the local model via A1-ML using HTTP GET method. Near-RT RIC replies with the status (Local Model Status Object), showing the timestamp of most recent local model update. Non-RT RIC decides whether a local model upload is needed.

In Example 10, the subject matter of Examples 1-9 optionally include where the Non-RT RIC requests the update of local model from Near-RT RIC via A1-ML using HTTP GET method. Near-RT RIC sends the local model object (LocalModelObject) in the response. The model object contains model file related information, e.g., file location, file size, file encoding method, etc. The model file is transferred over FTP, SFTP, or FTPeS, following the file information provided in LocalModelObject. Non-RT RIC update the model accordingly.

In Example 11, the subject matter of Examples 1-10 optionally include where the Near-RT RIC sends a notification (LocalModelStatusObject) via A1-ML using HTTP POST method. In addition to the update timestamp, the notification includes the reason of sending this notification. In one embodiment, the type of the reason includes: new update on local model available, local model got terminated, model id mismatch, etc. Non-RT RIC decides whether to upload the local model.

In Example 12, the subject matter of Examples 1-11 optionally include where the Non-RT RIC deletes the federated learning session via A1-ML using HTTP DELETE method. In some embodiments the models or learning may be referred to as artificial intelligence (AI)/ML models or AI/ML learning, respectively.

Although an aspect has been described with reference to specific exemplary aspects, it will be evident that various modifications and changes may be made to these aspects without departing from the broader scope of the present disclosure. Accordingly, the specification and drawings are to be regarded in an illustrative rather than a restrictive sense. This Detailed Description, therefore, is not to be taken in a limiting sense, and the scope of various aspects is defined only by the appended claims, along with the full range of equivalents to which such claims are entitled.

What is claimed is:

1. An apparatus for a Non real-time (Non-RT) radio access network intelligence controller (RIC)(Non-RT RIC) in an open radio access network (O-RAN), the apparatus comprising: memory; and, processing circuitry coupled to the memory, the processing circuitry configured to:
download a global machine learning (ML) model to Near-RT RICs;
upload local ML models from the Near-RT RICs, wherein the local ML models are based on the global ML model;
update the global ML model based on the local ML models to generate an updated global ML model; and
download the updated global ML model to the Near-RT RICs.

2. The apparatus of claim 1 wherein each of the uploaded local ML models comprises a model update type, the model update type indicating a compressed model for model update or a gradient for model update.

3. The apparatus of claim 1 wherein the processing circuitry is further configured to:
send put requests to the Near-RT RICs for a federated learning (FL) session, the FL session having a FL session object comprising the global ML model and a corresponding local ML model of the local ML models and having a corresponding FL session identification (ID).

4. The method of claim 3 wherein the processing circuitry is further configured to:
send a delete FL session to a Near-RT RIC of the Near-RT RICs, the delete FL session comprising a corresponding FL session ID.

5. The apparatus of claim 1 wherein the processing circuitry is further configured to:
send an ML capabilities request to a Near-RT RIC of the Near-RT RICs.
receive a response from the Near-RT RIC, the response comprising an array indicating the ML capabilities of the Near-RT RIC.

6. The apparatus of claim 5 wherein the send is via an A1 interface using Hypertext Transfer Protocol (HTTP).

7. The apparatus of claim 1 wherein the processing circuitry is further configured to:
receive a local ML model status object from a Near-RT RIC of the Near-RT RICs, the local model status object comprising a time stamp indicating a last model update and a notification reason indicating a reason for the local model status object being sent.

8. The apparatus of claim 7 wherein the processing circuitry is further configured to:
send a local ML model status object request to the Near-RT RIC; and
send a get a local ML model request to the Near-RT RIC if the local ML model status object indicates an update to the local ML model is available.

9. The apparatus of claim 1 wherein the processing circuitry is further configured to:
send a global ML model status object to the Near-RT RICs, the global ML model status object comprising a time stamp indicating a last model update and a notification reason indicating a reason for the global model status object being sent.

10. The apparatus of claim 9 wherein the processing circuitry is further configured to:
receive, from a Near-RT RIC of the Near-RT RICs, a query for the global ML model status object.

11. The apparatus of claim 1 wherein the processing circuitry is further configured to:
assign federal learning (FL) session identifications (IDs) (FL session IDs) to the Near-RT RICs, a corresponding FL session ID identifying the global ML model and a corresponding local ML model of a corresponding Near-RT RIC.

12. The apparatus of claim 1 wherein the download the global ML model to the Near-RT RICs is performed using the A1 interface and a Hypertext Transfer Protocol (HTTP) put method.

13. The apparatus of claim 1 further comprising transceiver circuitry coupled to the memory; and antennas coupled to the transceiver circuitry.

14. A non-transitory computer-readable storage medium that stores instructions for execution by one or more processors of a non real-time (Non-RT) radio access network intelligence controller (RIC)(Non-RT RIC) in an Open RAN (O-RAN) network, the instructions to configure the one or more processors to perform the following operations:
download a global machine learning (ML) model to Near-RT RICs;
upload local ML models from the Near-RT RICs, wherein the local ML models are based on the global ML model;
update the global ML model based on the local ML models to generate an updated global ML model; and
download the updated global ML model to the Near-RT RICs.

15. The non-transitory computer-readable storage medium of claim 14 wherein each of the uploaded local ML models comprises a model update type, the model update type indicating a compressed model for model update or a gradient for model update.

16. The non-transitory computer-readable storage medium of claim 14 wherein the operations further comprise:
send put requests to the Near-RT RICs for a federated learning (FL) session, the FL session having a FL session object comprising the global ML model and a corresponding local ML model of the local ML models and having a corresponding FL session identification (ID).

17. An apparatus for an Non-time (RT) radio access network intelligence controller (RIC)(Non-RT RIC) application (rApp) in an open radio access network (O-RAN), the apparatus comprising: memory; and, processing circuitry coupled to the memory, the processing circuitry configured to:
receive a global machine learning (ML) model from a Non-RT RIC;
update a local ML model based on the global ML model and data collected at the Near-RT RIC to generate an updated local ML model;
upload the updated local ML model to the Non-RT RIC; and
download an updated global ML model from the Non-RT RIC, wherein the updated global ML model is based on the updated local ML model.

18. The apparatus of claim 17 wherein the uploaded local ML model comprises a model update type, the model update type indicating a compressed model for model update or a gradient for model update.

19. The apparatus of claim 17 wherein the processing circuitry is further configured to:
receive a put request from the Non-RT RICs for a federated learning (FL) session, the FL session having a FL session object comprising: the global ML model, the local ML model, and a FL session identification (ID).

20. The apparatus of claim 17 further comprising transceiver circuitry coupled to the memory; and antennas coupled to the transceiver circuitry
